(19) United States
(12) Patent Application Publication
(10) Pub. No.: US 2002/0065008 A1
(43) Pub. Date: May 30, 2002

(54) Roll cover for flat work ironer

(76) Inventor: Michael T. Stanhope, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/918,884

(22) Filed: Jul. 31, 2001

Related U.S. Application Data
(60) Provisional application No. 60/221,753, filed on Jul. 31, 2000.

(51) Int. Cl. B32B 5/02; B32B 27/04; B32B 27/12; D03D 15/00; D03D 25/00

(52) U.S. Cl. 442/181; 442/103; 442/102

(57) ABSTRACT

A roll cover for use on a flat work ironer is provided, having an improved texture. The roll cover is a sheet of thermally resistant fabric that is coated or impregnated with a mixture of an acrylic resin and a stiffening agent. The improved roll cover is textured, preferably with ridges, so as to grip fabric more effectively.

### CROSS-REFERENCE TO RELATED APPLICATION

This application is related to U.S. provisional patent application entitled “Textured Fabric for Use on Roll Covers for Flat Work Ironers” filed on Jul. 31, 2000, and accorded Ser. No. 60/221,753, which is entirely incorporated herein by reference.

### TECHNICAL FIELD

The invention relates to a roll cover for a flat work ironer of the type provided with a plurality of ironing rolls for ironing flat work as the flat work is caused to move between a steam chest and the rolls. More specifically, the invention is directed to a roll cover that is formed by coating a thermally resistant fabric with an acrylic resin blended with a stiffening agent.

### BACKGROUND OF THE INVENTION

A flat work ironer is a machine used in commercial or industrial laundries that serve large institutions such as hotels, hospitals, or restaurants to mechanically heat and press flat items such as bed linens, aprons, table linens, etc. The machine has a series of parallel rolls that are positioned in complementary-shaped semi-cylindrical polished seats formed in a chest that is heated by means of gas, steam, or thermal liquids such as hot oil.

The ironer causes the flat work to be pressed between the heated chest and each roll in succession. The complementary shape of the rolls versus the shapes of the polished seats of the heated chest causes the flat work to be retained in contact with the heated chest longer than it would be if the heated chest were flat, in order to cause the moisture in the flat work to quickly evaporate and to remove the folds and wrinkles from the flat work. The chest typically is heated to and maintained at a temperature of at least approximately 300° F. but may reach temperatures of up to 450° F. The flat work typically is partially wet after having been washed and spun to a damp condition and is then fed in at one end of the ironer by a surface conveyor, passed between the heated chest and the rolls and output at the other end of the ironer in a substantially dry and wrinkle-free condition.

Typically, the rolls are fabricated of stainless steel and are hollow with a perforated cylindrical skin and perforated end walls to allow steam generated in the ironing process to pass from about the cylindrical surfaces of the rolls into the interior of the rolls where it is removed by a vacuum system through one or both of the end walls of the roll. This creates air movement through and about the flat work so as to remove the high humidity air from about the ironer. The rolls usually are wrapped with a cushioning pad and then with an outer roll cover. The cushioning pad is typically made of a thermally resistant material. In the past, asbestos was used for this purpose. More recently, this material is a combination of polyester and cotton or 100% aramid or a combination of aramid, polyester, and/or cotton.

The roll covers must be thermally stable and hydrolysis resistant to provide for a wear life of at least one year under use of at least 40 hours per week. The covers should be of adequate stiffness to ensure a wrinkle free and smooth ironing surface. However, the cover should be porous to allow for the passage of steam through the cover.

In the past, roll covers for flat work ironers have been manufactured of asbestos fabric. For example, U.S. Pat. No. 2,333,824 to Schoepf teaches an ironer roll where both the pad and the outer cover are manufactured from asbestos. U.S. Pat. No. 2,497,696 to Smith teaches a cover made of asbestos fibers adhesively applied to a underlying pad. Other covers taught by the prior art references have been composed of muslin or duck, see U.S. Pat. No. 1,539,916 to Siever, and aluminum, see U.S. Pat. No. 2,762,111 to Morgan.

U.S. Pat. No. 3,811,164 to Faress, et al. teaches the use of a cover composed of a fabric that has been impregnated with a thermosetting resinous material, specifically a phenolic resin. Preparation of phenolic resins requires the use of the chemical phenol, which is a hazardous substance.

There are some disadvantages to use of the roll covers as taught by the prior art. Perhaps the most obvious are the environmental and health dangers associated with asbestos and phenol. Other problems with prior art roll covers include attaining desired characteristics such as porosity, smoothness, heat resistance, and wear resistance. Another disadvantage of known covers made with conventional fabrics is that they may not be rough enough to prevent slipping of the fabric in rolls. If the fabric slips, it may become wrinkled or damaged.

Thus, a heretofore unaddressed need exists in the industry to address the aforementioned deficiencies and inadequacies.

### SUMMARY OF THE INVENTION

The present invention provides a roll cover for a flat work ironer and methods for manufacturing the roll cover and gripping fabrics.

Briefly described, one embodiment of the roll cover, among others, can be designed as follows. The woven roll cover fabric for a roll of a flat work ironer may include inherently flame resistant yarns in warp direction; textured yarns in the warp and/or filling directions; and a finish on the fabric. The fabric may further include ridges adapted to grip a fabric passed over or under the roll of the flat work ironer. Both the warp yarns and the filling yarns may be made of at least one of polyester, polybenzimidazole, polytetrafluoroethylene, polyetheretherketone, polyetherimide, polyethersulfone, polyimide, polyamide, polyimide-amide, modacrylic, acrylic, melamine, and glass.

The present invention can also be viewed as providing methods for manufacturing the roll cover and gripping fabrics. In this regard, one embodiment of a method for manufacturing a roll cover, among others, can be broadly summarized by the following steps: fabricating a woven fabric including inherently flame resistant yarns in warp and/or filling direction, textured yarns in warp and/or filling direction, and a finish on the fabric; and coating the woven fabric with a resin blend.

A method is also disclosed for gripping fabric that is passed through a roll cover of a flat work ironer. In this regard, one embodiment of the method, among others, can be broadly summarized by the following steps: providing a woven fabric comprising inherently flame resistant yarns in warp and/or filling direction and textured yarns in the warp and/or filling direction; coating the woven fabric with a resin blend; and attaching the coated woven fabric to a roll of the flat work ironer.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective illustration of a flat work ironer.

FIG. 2 is a side view of a pair of rolls of the flat work ironer and corresponding recesses of the heated chest.

FIG. 3 is a detailed cross-sectional view of a roll showing one embodiment of assembly of the roll core, pad, and cover.

FIG. 4 is a detailed cross-sectional view of a roll showing a second embodiment of assembly of the roll core, pad, and cover.

FIG. 5 is an exploded perspective view of a roll core with attached vacuum system and rotation shaft.

FIG. 6 is a perspective illustration of the textured fabric of the roll cover of the flat work ironer of FIG. 1.

FIG. 7 is a cross-sectional view of the fabric of FIG. 6.

### DETAILED DESCRIPTION

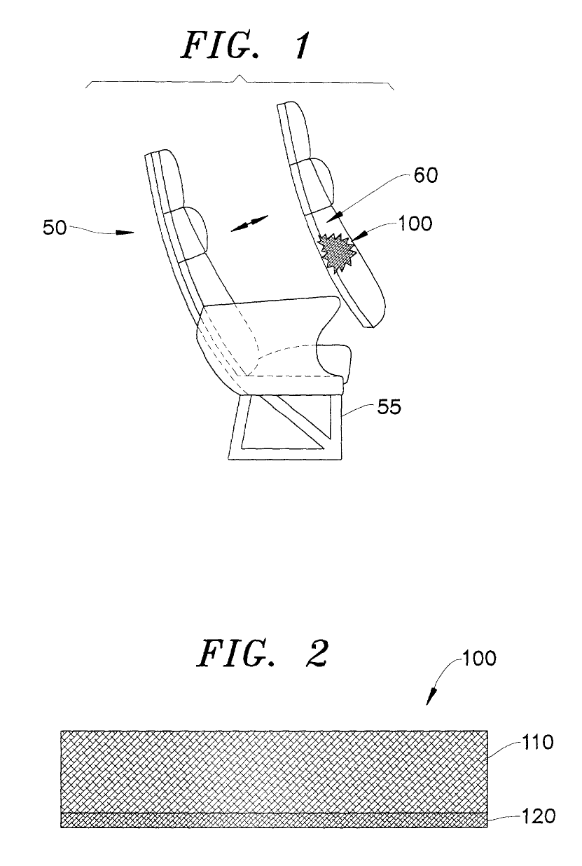

Referring now in more detail to the drawings, FIG. 1 shows a flat work ironer 10 of the type typically used for ironing flat fabric goods such as tablecloths, napkins, bed sheets, etc. Flat work iron 10 is only an example, and other configurations are feasible. Ironer 10 is presented for purposes of explanation only. Ironer 10 includes a work table, or surface conveyor 12, which includes an entry roll 14, a return roll 16, and conveyor belts 18 that extend around the entry roll 14 and return roll 16 and rotate in the direction indicated by arrow 19. One of the rolls of the surface conveyor 12, such as return roll 16, is driven by an electric motor 22 (FIG. 5). Feed roll bar 24 extends across surface conveyor 12 and rotates oppositely from conveyor belts 18, in the direction indicated by arrow 25. Heated chest 26 lies adjacent and parallel to and at the same level as surface conveyor 12 and is heated to a temperature of, preferably, 300° F. to 330° F. by means which are known in the field, preferably by means of circulating hot gas, steam or hot oil. A plurality of polished parallel recesses 28 (FIG. 2) are formed in the top surface of heated chest 26 and are essentially semi-cylindrical troughs which correspond in shape and size to rolls 30 and which function as seats for the rolls 30. A series of typically six rolls 30 (only four are illustrated in FIG. 1) extend across heated chest 26, oriented essentially parallel to each other.

As shown more clearly in FIG. 5, a roll 30 has roll core 32, which typically is a stainless steel cylinder having a cylindrical wall 33. In the preferred embodiment, roll core 32 defines a plurality of perforations 34 in cylindrical wall 33, which function as air passages. Each roll core 32 is enclosed on both ends by end plates 36 which have extended therefrom shafts 38 that are connected to electric motor 22 and an intermediate drive system 40 to rotate rolls 30. At least one end plate 36 of the roll core 32 also has slidably attached thereto a stationary vacuum shoe 42 that communicates with the inlet of a blower 44 so that the blower 44 pulls a vacuum on the interior area of roll core 32.

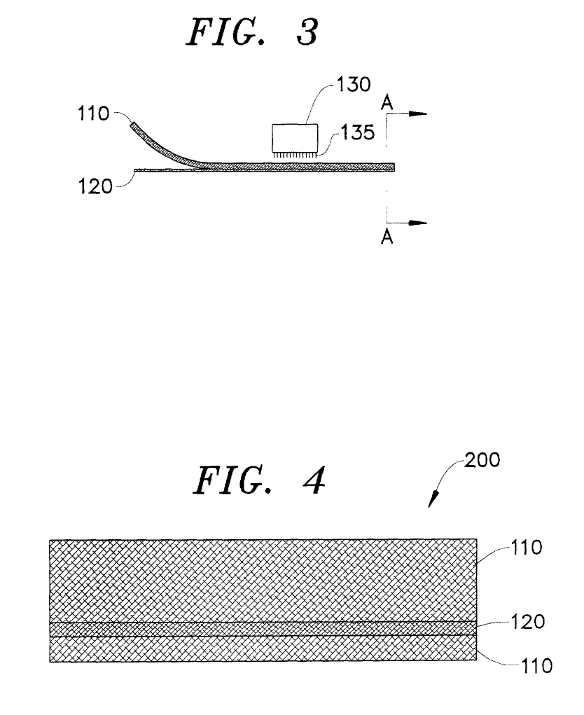

FIGS. 3 and 4 show the construction of a roll 30 in more detail. A heat and moisture resistant pad 46 wraps around roll core 32. The pad 46 may be protected from contact with the roll core 32 by placement of a screen cloth 45 (FIG. 3) between the roll core 32 and the pad 46. Screen cloth 45 can be made of any heat-resistant material, such as aramid fiber. Pad 46 is of substantially the same width as the length of roll core 32 and of sufficient length to wrap around roll core 32 one time. Preferably, pad 46 wraps around roll core 32 slightly less than one time so that as the roll 10 is used and pad 46 becomes compressed it does not start to overlap on itself. The trailing end of pad 46 trails freely behind, as the roll 30 rotates in the direction away from the trailing end, as indicated by arrow 31.

Pad 46 can be composed of any of several suitable materials that are used in the field. For example, pad 46 can be a mixture of polyester and cotton, 100% aramid, or a mixture of aramid, polyester, and/or cotton. “Aramid” is the generic name for fiber made from the condensation product of isophthalic or terephthalic acid and m- or p-phenylenediamine. Pad 46 also can be a stainless steel knitted material.

Roll cover 50 of the invention is positioned about pad 46. Preferably, the leading end 51 of cover 50 is attached to roll core 32 by fasteners such as series of rivets or grommets 49. As shown in FIG. 3, which shows the assembly of a roll when a screen cloth 45 is placed between the roll core and the pad, cover 50 is fastened to roll core 32 at a line of connection 53 on roll core 32 ahead of attachment of pad 46. Cover 50 is spirally wound around roll core 32 on top of pad 46 and wraps round pad 46 and roll core 32 approximately two times.

In a second embodiment of the roll cover 50, pad 46 and roll 30 is shown in FIG. 4. This assembly of the roll 30 and its cover 50 may be preferable when a screen cloth 45 is not used. In the second embodiment, cover 50 is attached to the roll core 32 at a line on roll core 32 past the line of attachment of pad 46. Cover 50 thus wraps around roll core 32 once under pad 46, then a second time on top of pad 46. In both embodiments of the invention, the free end 52 of cover 50 is not fastened but instead trails freely. As the roll 10 is used, this trailing end 52 can move to avoid bunching up of the cover 50 with expansion, compression or stretching of the pad or cover.

Cover 50 is formed of a resin-coated thermally resistant fabric. The base fabric is one that can withstand exposure to temperatures up to 450° F. for prolonged periods of time, as well as a wide range of pH values to which the fabric might be subjected. An example of an appropriate fabric is one made from woven aramid fiber, such as para-aramids or meta-aramids. Other suitable fabric materials, by example, are flame resistant polyester, polybenzimidazole, polytetrafluoroethylene, polyetheretherketone, polyetherimide, polyethersulfone, polyimide, polyamide, polyimide-amide, modacrylic, acrylic, melamine, and glass. The base fabric of cover 50 is woven and coated with a resin blend by means that are known in the art.

Referring now to FIGS. 6 and 7, FIG. 6 depicts a perspective view of the fabric used to construct the roll cover 50. As indicated in this figure, the fabric preferably comprises a plurality of textured yarns 53. FIG. 7 is a cross section of the fabric of the roll cover 50, also showing the textured yarns 53. The textured yarns 53 are yarns that have been processed to develop stretch or bulk in portions of the yarn. In various embodiments of the invention, the textured yarns 53 may be used in the warp and/or the filling direction of the woven fabric of the roll cover 50. Through overfeeding the diameter of the bulked portions of the textured yarns 53 may be increased or decreased. The bulk portions of the textured yarns 53 may vary both in length and in denier, depending on the extent of over-feeding. Further, the percentage of the yarns that are textured may vary from greater than 1% to 100%. The over-fed bulked portions of the textured yarn may be approximately one-fourth to three times the denier of the yarn that is not over-fed. The amount and size of the bulk portions of the textured yarns 53 and the amount of yarns that are textured in the roll cover 50 will depend on the length, width, weight, and thickness of the flat work 54 that is gripped by the roll cover 50.

Generally, the yarns of the roll cover 50 may be textured by crimping, imparting of random loops, or otherwise modifying continuous filament yarn to increase abrasion resistance, resilience, moisture absorption, or to provide a rougher surface texture. The textured yarns 53 lend a roughness of hand to the fabric of the roll cover 50, usually resulting in the formation of ridges 55 that enable the roll cover 50 to grip flat work 54 (FIG. 1) more effectively. By gripping flat work 54 more effectively, the improved rough fabric of the roll cover 50 prevents the flat work 54 from slipping, thereby also preventing damage or wrinkles to the fabric. Preferably, the ridges 55 formed by the textured yarns 53 of the fabric of the roll cover 50 are not so pronounced so as to leave impressions on the flat work 54 after it has been cleaned and/or pressed.

Typically, a resin bath is used to coat the fabric evenly on both sides. The fabric is completely submerged in the bath and then the fabric is removed from the bath and rollers are used to squeeze the excess resin off the fabric. Alternatively, a system designed to apply latex to the back of carpet may be used. In this system, the fabric passes over the top of a roller that is half submerged in the resin bath. As the roller rotates it applies resin to the fabric and excess resin is then removed from the fabric using a scraper blade. The fabric is then placed in an oven to dry the fabric and cure the resin. Typically, the drying/curing is accomplished using a tenter frame at an oven temperature of approximately 390° to 400° F. and the fabric is passed through the oven at a rate of approximately 5-20 yards per minute. Additionally, a combination of both of these methods may be employed. Either acrylic or phenolic resins may be used to coat the fabric; however, acrylic resin cures more quickly than phenolic resins. Therefore, the acrylic resin coated fabric can be passed through the oven at a faster rate and the cost of curing the product is lower than the cost of curing the phenolic-coated product.

The resin blend can be from about 4 to 40% by weight acrylic resin, preferably about 16 to 26%, and from about 2.5 to 30% by weight of a stiffening agent, preferably from about 5 to 15%. An anti-migrant agent may also be included, as may a cross-linking catalyst such as ammonium chloride. If these are included they are each typically <1% by weight of the blend. The remainder of the bath is normally water. It is also anticipated that other resins may be used, such as, for example, a self cross-linking acrylic resin. In this case, a stiffening agent would not be required.

Preferred acrylic resins are acrylic copolymers such as, for example, GLOCRYL™. GLOCRYL™ is the tradename for an anionic self-crosslinking acrylic copolymer manufactured by Glo-Tex Chemicals, Inc., of Roebuck, S.C. This acrylic copolymer has a boiling point of 212° F., a vapor pressure of 17 mmHg at 20° C., a specific gravity of 1.1 and is 55% volatile. The acrylic copolymer is an opaque water-based emulsion, 55% water, with a low acrylic odor.

A stiffening agent is added to the acrylic resin in the resin bath to increase the “hand” (i.e., feel) and stiffness of the final coated fabric. The stiffening agent cross-links with the acrylic copolymer and forms a stiffer polymer than the acrylic copolymer would form polymerizing with itself. Stiffening agents include for instance aqueous polymeric solution, hexamethoxymethyl-melamine, modified fatty amides, modified alkyl resin, modified formaldehyde carbamate, modified urea formaldehyde carbamate, melamine-formaldehyde, polyvinyl acetate, polyvinyl alcohol, polyurethane, polyethylene emulsion, polyether thermoplastic polyurethane, triazine-formaldehyde condensate, vinyl copolymers with modified starch, other thermoplastic resins, and other thermoset resins.

An antimigrant agent may be added to the resin blend to stop migration of dye particles through the coated fabric and to maintain uniformity of color shade across the coated fabric. Examples of anti-migrant agents that are suitable are nonionic, linear polymeric anhydride, anionic polyacrylamide, and formulated polyamide anti-migrant agents. ASTROTHERM AM™, a formulated polyamide manufactured by GLO-TEX Chemicals, Inc. of Roebuck, S.C., is presently deemed suitable for this purpose.

A cross-linking catalyst, such as ammonium chloride, may be included in the resin to speed up the polymerization reaction between the stiffening agent and the acrylic copolymer. The resin blend may also include one or more coloring agents, such as pigments and dyes, to impart to the coated fabric the desired color. Acid dyes are suitable for this purpose due to the small size of these dye particles. However, any coloring agents which do not migrate across the fabric and which do not leach off of the fabric during use of the roll covers would be suitable as well.

Operation

Flat work 54, preferably dampened, shown in FIGS. 1 and 2 as a table napkin, enters ironer 10 across surface conveyor 12 via transportation by conveyor belts 18 and feed roll bar 24. Flat work 54 follows the movement of directional arrows 56 shown in the several views of the invention. Flat work 54 then moves across heated chest 26 and sequentially through each recess 28 and underneath each roll 30. Rolls 30 rotate in the direction indicated by arrow 31 and push/pull flat work 54 across the ironer 10. Each roll 30 contacts flat work 54 and flat work 54 is pressed or ironed between each roll in its corresponding recess. This contact with heated chest 26 and each roll 30 presses and dries flat work 54. The moisture from flat work 54 is evaporated into the air and also is pulled from flat work 54 by the vacuum created in the interior of roll core 32. Thus, moisture is pulled from flat work 54 through cover 50 and pad 46 and through the perforations 34 of roll core 32. The moisture is then pulled out of the ironer by vacuum means. Flat work 54 exits ironer 10 pressed and dried. The speed of rolls 30 can be adjusted to ensure flat work 54 stays in the ironer long enough to become dry.

It can be envisioned by one skilled in the art that there exist various alternative roll covers, woven materials, and methods of fabricating the roll covers. Listed below are three exemplary methods of fabricating the roll cover.

### EXAMPLE 1

A roll cover was fabricated as follows:

A woven material could be formed with aramid warp and filling yarns, with 37.5 warp yarns per inch and 37 filling yarns per inch. All or part of the filling yarn is textured. The denier of both yarns was 665 (16/2 cotton count).

Once the fabric was woven, it was submerged in a bath of acrylic resin, a stiffening agent and dyes. The acrylic resin was GLOCRYL NCR™, and the stiffening agent was AEROTEX M-3™ resin. The acrylic resin of the liquid mixture was 21% by weight, the stiffening agent was 9% by weight. Acidol dyes from BASF, Red, Blue, and Yellow may be used to color the fabric.

Also included in the bath were an anti-migrant (Astrotherm AM™—0.90%), and a catalyst (ammonium chloride—0.50%). The liquid bath was maintained at ambient room temperatures. The dyes were separately dissolved in hot water before mixing with the other diluted ingredients.

The fabric was submerged in the resin and then run through a pair of pad rollers that squeezed the excess resin out of the fabric. Because this was a continuous operation, the time of submersion varied with the speed of the tenter frame. The pad rollers maintain a constant pressure, however, and therefore resin pick-up tends to be uniform regardless of production speeds.

The resin-impregnated fabric was then passed through a drying oven maintained at approximately 400° F. for a period of 2 to 3 minutes. The rate of passage of the fabric was approximately 15 yards per minute. The fabric passed through cooling zones at the end of the oven, which brought the temperature down to approximately 150° F. or less, before being rolled up on an automatic wind-up unit.

### EXAMPLE 2

The process of Example 1 was repeated with the following changes:

The resin blend was 4% by weight acrylic resin, 2.5% by weight stiffening agent, a cross-linking catalyst, and the balance water. The resulting fabric had less stiffness than the fabric of Example 1.

### EXAMPLE 3

The process of Example 1 was repeated with the following changes:

The resin blend was 15% by weight acrylic resin, 6% by weight stiffening agent, 1% by weight antimigrant agent, 0.5% by weight catalyst, 0.060% by weight red dye, 0.028% by weight blue dye and 0.750% by weight yellow dye. The resulting fabric performed acceptably, although the hand was softer than was the fabric of Example 1.

It should be emphasized that the above-described embodiments of the present invention, are merely possible examples of implementations, and are merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Having thus described the invention, at least the following is claimed:

1. A woven cover fabric for a roll of a flat work ironer, comprising:
inherently flame resistant yarns;
textured yarns; and
a finish on the fabric.

2. The roll cover of claim 1, wherein the textured yarns are in the warp or filling direction.

3. The roll cover of claim 1, wherein the textured yarns are in the warp and filling direction.

4. The roll cover of claim 1, wherein the textured yarns form ridges adapted to grip a fabric passed over or under the roll of the flat work ironer.

5. The roll cover of claim 1, wherein the yarns comprise at least one of polyester, polybenzimidazole, polytetrafluoroethylene, polyetheretherketone, polyetherimide, polyethersulfone, polyimide, polyamide, polyimide-amide, modacrylic, acrylic, melamine, and glass.

6. The roll cover of claim 1, wherein the textured yarns comprise at least one of polyester, polybenzimidazole, polytetrafluoroethylene, polyetheretherketone, polyetherimide, polyethersulfone, polyimide, polyamide, polyimide-amide, modacrylic, acrylic, melamine, and glass.

7. The roll cover of claim 1, wherein the over-fed bulked portions of the textured yarn may be approximately one-fourth to approximately three times the denier of the yarn that is not over-fed.

8. The roll cover of claim 1, wherein the finish is a mixture comprising an acrylic resin and a stiffening agent.

9. The roll cover of claim 1, wherein the roll cover fabric has a rough hand.

10. A woven cover fabric for a roll of a flat work ironer, comprising:
inherently flame resistant yarns, the inherently flame resistant yarns including aramid yarns;
textured yarns, the textured yarns including polyester yarns; and
a finish on the fabric.

11. The roll cover of claim 10, wherein the textured yarns are in the filling or warp direction.

12. The roll cover of claim 10, wherein the textured yarns are in the filling and warp direction.

13. The roll cover of claim 10, wherein the textured yarns form ridges that grip flat work passed over or under the roll of the flat work ironer.

14. The roll cover of claim 10, wherein the ridges are disposed in a transverse direction to the roll.

15. The roll cover of claim 10, wherein the yarns comprise at least one of polyester, polybenzimidazole, polytetrafluoroethylene, polyetheretherketone, polyetherimide, polyethersulfone, polyimide, polyamide, polyimide-amide, modacrylic, acrylic, melamine, and glass.

16. The roll cover of claim 10, wherein the textured yarns comprise at least one of polyester, polybenzimidazole, polytetrafluoroethylene, polyetheretherketone, polyetherimide, polyethersulfone, polyimide, polyamide, polyimide-amide, modacrylic, acrylic, melamine, and glass.

17. The roll cover of claim 10, wherein the over-fed bulked portions of the textured yarn may be approximately one-fourth to approximately three times the denier of the yarn that is not over-fed.

18. The roll cover of claim 10, wherein the finish is a mixture comprising an acrylic resin and a stiffening agent.

19. The roll cover of claim 10, wherein the roll cover fabric has a rough hand.

20. The roll cover of claim 10, wherein the roll cover fabric can withstand temperatures up to approximately 450° F.

21. A method for manufacturing a roll cover for a flat work ironer, comprising the steps of:
fabricating a woven fabric comprising:
inherently flame resistant yarns,
textured yarns, and
a finish on the fabric; and
coating the woven fabric with a resin blend.

22. The method of claim 21, further comprising forming ridges in the filling direction of woven fabric.

23. The method of claim 21, further comprising forming ridges in the warp direction of woven fabric.

24. The method of claim 21, wherein the step of coating the woven fabric with a resin blend comprises coating the woven fabric with a resin blend comprising a stiffening agent.

25. The method of claim 21, wherein the step of coating the woven fabric with a resin blend comprises coating the woven fabric with a resin blend comprising an anti-migrant agent.
